(19) United States
(12) Patent Application Publication
(10) Pub. No.: US 2023/0271137 A1
(43) Pub. Date: Aug. 31, 2023

(54) NANO MEMBRANE, NANO MEMBRANE ASSEMBLY, AND METHOD FOR MANUFACTURING NANO MEMBRANE

(71) Applicant: KOLON MATERIAL, INC., Gyeonggi-do (KR)

(72) Inventors: Jeong Young CHOI, Busan (KR); Sung Jin KIM, Daegu (KR); Jun Young PARK, Siheung (KR); Beom June LEE, Seoul (KR); Ki Taek NAM, Ansan (KR)

(21) Appl. No.: 18/007,489

(22) PCT Filed: Aug. 26, 2020
(86) PCT No.: PCT/KR2020/011401

§ 371 Date: Jan. 31, 2023

(30) Foreign Application Priority Data
Jul. 31, 2020 (KR) 10-2020-0095919

(51) Int. Cl. B01D 61/02; D04H 1/728; B01D 67/00

(52) U.S. Cl. CPC B01D 61/027; D04H 1/728; B01D 67/0002; B01D 2325/0283; B01D 2325/04; B01D 2325/20; B01D 2323/10; B01D 2325/26

(57) ABSTRACT

Disclosed is a nano membrane which has improved dustproofness and thus effectively prevents matter, contaminants/dust, and the like from getting into an electronic device such as a PCB or a MEMS microphone, and has no air and sound permeability degradation. The nano membrane of the present disclosure contains a plurality of pores having an average diameter of 0.5-20 μm, wherein the maximum diameter of each of the pores is 30 μm, the minimum diameter of each of the pores is 0.1 μm, and the porosity of the nano membrane is 50-90%.

### CROSS-REFERENCE TO RELATED APPLICATION

THE PRESENT APPLICATION CLAIMS PRIORITY UNDER 35 U.S.C. 119(A) TO KOREAN PATENT APPLICATION NO. 2022-0095919, FILED ON Jul. 31, 2020. THE ENTIRE DISCLOSURE OF ABOVE PATENT APPLICATIONS IS INCORPORATED HEREIN BY REFERENCE.

### TECHNICAL FIELD

The present disclosure relates to a nanomembrane having excellent dust resistance and an assembly including the nanomembrane.

### BACKGROUND ART

Electronic devices such as printed circuit boards (PCBs), sensors, microelectromechanical systems (MEMSs), etc. are provided with a nanomembrane that allows sound and air to pass bidirectionally therethrough and prevents foreign substances such as dust and the like from entering inside. Thorough research and development is ongoing to improve dust resistance without reducing the air and sound permeability of the nanomembrane.

Korean Patent Application Publication No. 10-2017-0094396 discloses a vent assembly including an environmental barrier membrane, but a method of improving dust resistance without reducing the permeability of the membrane is not mentioned.

### DISCLOSURE

### Technical Problem

It is an object of the present disclosure to provide a nanomembrane that effectively prevents substances, pollutants/dust, and the like from entering electronic devices such as PCBs, MEMSs, etc. with improved dust resistance, and does not reduce air and sound permeability.

### Technical Solution

An embodiment of the present disclosure provides a nanomembrane including a plurality of pores having an average diameter of 0.5 to 20 μm, with a maximum pore diameter of 30 μm, a minimum pore diameter of 0.1 μm, and a porosity of 50 to 90%.

The material constituting the nanomembrane may have a volume resistance of 1.6 to 2.0×10¹⁶ Ω·cm (ASTM D257) and a dielectric strength of 200 to 600 kV/mm (ASTM D149).

The material may be polyimide (PI), polyacrylonitrile (PAN), polymethyl methacrylate (PMMA), polystyrene (PS), styrene methyl methacrylate (SMMA), or styrene acrylonitrile (SAN).

The nanomembrane may have a thickness of 1 to 30 μm.

The air permeability of the nanomembrane may be 1 to 200 cm³/cm²/sec.

The unit weight of the nanomembrane may be 0.1 to 10 g/m².

The density of the nanomembrane may be 0.1 to 1.0 g/cm³.

The dust collection efficiency of the nanomembrane according to the following method may be 95% or more. In the method of measuring dust collection efficiency, measurement is performed using an AFT 8130 at a dust size of 5 μm, an air flow rate of 32 L/min, and a measurement area of 100 cm².

The thermal shrinkage of the nanomembrane at 300° C. may be 1% or less.

The weight reduction of the nanomembrane at 300° C. may be 1% or less.

The nanomembrane may be configured such that nanofibers are integrated in the form of a non-woven fabric.

Another embodiment of the present disclosure provides a dustproof nanomembrane including a plurality of pores having an average diameter of 0.5 to 20 μm, with a porosity of 50 to 90%, a thickness of 1 to 30 μm, air permeability of 1 to 200 cm³/cm²/sec, and dust collection efficiency of 95% or more according to the following measurement method. In the method of measuring dust collection efficiency, measurement is performed using an AFT 8130 at a dust size of 5 μm, an air flow rate of 32 L/min, and a measurement area of 100 cm².

Still another embodiment of the present disclosure provides a dustproof nanomembrane assembly including a nanomembrane, an adhesive provided on one surface of the nanomembrane, and a carrier provided on one surface of the adhesive.

Yet another embodiment of the present disclosure provides a nanomembrane assembly for a microelectromechanical system (MEMS) attached to a microelectromechanical system to prevent foreign substances from entering inside of the microelectromechanical system, including a nanomembrane having a plurality of pores having an average diameter of 0.5 to 20 μm and made of a material having a volume resistance of 1.6 to 2.0×10¹⁶ Ω·cm (ASTM D257) and a dielectric strength of 200 to 600 kV/ram (ASTM D149), an adhesive provided on the nanomembrane, and a carrier provided on the adhesive.

Still yet another embodiment of the present disclosure provides a method of manufacturing a nanomembrane, including electrospinning a polyamic acid solution to prepare a precursor, processing the precursor to adjust a density and thickness of the precursor, converting the precursor to determine a shape of the precursor, and curing the converted precursor, wherein, in electrospinning the polyamic acid solution, air is blown in a direction in which the precursor is discharged.

The polyamic acid solution may have a solid content of 5 to 30 wt % and a solution viscosity of 200 to 300 poise.

A discharge speed during electrospinning may be 3 to 8 ml/min.

Processing the precursor may be performed by applying a pressure of 20 to 200 kgf/cm² at a temperature of 20 to 100° C.

Curing the converted precursor may be performed for 10 to 30 minutes at 200 to 400° C.

### Advantageous Effects

According to embodiments of the present disclosure, it is possible to improve dust resistance without lowering air and sound permeability.

### DESCRIPTION OF DRAWINGS

FIG. 1 shows digital microscope images of a polyimide nanomembrane according to an embodiment of the present disclosure, a conventional polyimide membrane, and a conventional PVDF polyimide membrane;

FIG. 2 shows a nanomembrane assembly including the nanomembrane according to another embodiment of the present disclosure;

FIG. 3 shows a photograph of the nanomembrane assembly;

FIG. 4 is a flowchart showing a process of manufacturing a nanomembrane according to still another embodiment of the present disclosure; and

FIG. 5 is a graph showing thermogravimetric curves of the polyimide nanomembrane manufactured in Example 1 and the PVDF nanomembrane manufactured in Comparative Example 1.

### MODE FOR INVENTION

Hereinafter, embodiments of the present disclosure will be described in detail with reference to the accompanying drawings so that those skilled in the art may easily carry out the present disclosure. However, the present disclosure may be embodied in many different forms and is not limited to the embodiments described herein. Like reference numerals have been assigned to like parts throughout the specification.

An embodiment of the present disclosure pertains to a nanomembrane 100 including a plurality of pores having an average diameter of 0.5 to 20 μm. Here, a maximum pore diameter is 30 μm and a minimum pore diameter is 0.1 μm. The average diameter of the pores is preferably 1 to 10 μm. The porosity of the nanomembrane 100 is 50 to 90%, preferably 60 to 85%.

If the average diameter of the pores is less than 0.5 μm, if the minimum pore diameter is less than 0.1 μm, or if the porosity is less than 50%, dust resistance is excellent, but sound permeability may be reduced and sound loss may occur, and also, when manufacturing the MEMS microphone, the internal pressure of the MEMS microphone may increase, causing physical damage to the MEMS microphone. On the other hand, if the average diameter of the pores exceeds 20 μm, if the maximum pore diameter exceeds 30 μm, or if the porosity exceeds 90%, dust resistance may be deteriorated.

The material constituting the nanomembrane 100 has a volume resistance of 1.6 to 2.0×10¹⁶ Ω·cm (ASTM D257) and a dielectric strength of 200 to 600 kV/ram (ASTM D149). If the volume resistance and dielectric strength thereof are less than the above lower limits, sufficient static electricity may not be generated, dust resistance may be deteriorated, and the resulting nanomembrane may be unsuitable for use in MEMS microphones. On the other hand, if they exceed the above upper limits, excessive static electricity may generate electrical noise on the MEMS microphone and PCB.

The material having such characteristics enhances the effect of collecting foreign substances such as dust and the like by generating static electricity due to friction. Thereby, dust resistance of the nanomembrane 100 is improved.

The material forming the nanomembrane 100 may include polyimide (PI), polyacrylonitrile (PAN), polymethyl methacrylate (PMMA), polystyrene (PS), styrene methyl methacrylate (SMMA), or styrene acryl onitrile (SAN).

In particular, since polyimide has excellent heat resistance, loss due to heat may be reduced, and thus the lifespan of the nanomembrane 100 may be increased.

In this way, the nanomembrane 100 according to the present disclosure is made of a material that generates static electricity, thus exhibiting excellent dust resistance despite having pores with a large diameter. Also, since it has pores with a large diameter, sound loss is minimized.

The nanomembrane 100 may have a thickness of 1 to 30 μm, preferably 2 to 20 μm. If the thickness of the nanomembrane 100 is less than 1 μm, the internal pressure of the MEMS microphone may increase during manufacture of the MEMS microphone, which may cause physical damage to the MEMS microphone, and dust resistance may be deteriorated. On the other hand, if the thickness of the nanomembrane 100 exceeds 30 μm, dust resistance may be excellent, but sound permeability may be reduced and sound loss may occur.

The air permeability of the nanomembrane 100 may be 1 to 200 cm³/cm²/sec, preferably 100 to 200 cm³/cm²/sec. If the air permeability thereof is less than 1 cm³/cm²/sec, dust resistance is excellent, but when manufacturing the MEMS microphone, the internal pressure of the MEMS microphone may increase, which may cause physical damage to the MEMS microphone, and sound loss may occur due to a decrease in sound permeability. On the other hand, if the air permeability thereof exceeds 200 cm³/cm²/sec, dust resistance may be deteriorated.

The unit weight of the nanomembrane 100 may be 0.1 to 10 g/m², preferably 0.3 to 5 g/m². If the unit weight thereof is less than 0.1 g/m², the nanomembrane 100 may be damaged by vibration and shock during manufacture and use of the MEMS microphone. On the other hand, if the unit weight thereof exceeds 10 g/m², sound loss may occur in the MEMS microphone or PCB.

The nanomembrane 100 may have a density of 0.1 to 1.0 g/cm³. If the density thereof is less than 0.1 g/cm³, the amount of static electricity that is generated may be small, and dust resistance may be deteriorated. On the other hand, if the density thereof exceeds 10 g/cm³, noise may occur in the sound signal of the MEMS microphone or PCB.

The dust collection efficiency of the nanomembrane 100 according to the following measurement method is 95% or more, preferably 98% or more. If the dust collection efficiency thereof is less than 95%, foreign substances may enter the MEMS microphone when manufacturing the MEMS microphone and may thus affect the quality of the MEMS microphone.

In the method of measuring dust collection efficiency, measurement is performed using an AFT 8130 (made by TSI) at a dust size of 5 μm, an air flow rate of 32 L/min, and a measurement area of 100 cm².

The thermal shrinkage of the nanomembrane 100 at 300° C. is 1% or less, and the weight reduction thereof is 1% or less.

When manufacturing the MEMS microphone, the internal temperature of the MEMS microphone rises up to 270° C. due to soldering, but each of the thermal shrinkage and weight reduction at 300° C. of the nanomembrane 100 according to the present disclosure may be 1% or less, making it possible to prevent damage to the nanomembrane 100 due to heat during manufacture of the MEMS microphone.

The nanomembrane 100 may be configured such that nanofibers are integrated in the form of a nonwoven fabric. Since the nanomembrane 100 is in a nonwoven fabric form, it has excellent air permeability compared to non-porous membranes, wet/dry membranes, punched/perforated films, etc. Therefore, air and sound permeability may not be lowered, and dust resistance may be improved, such that foreign substances such as dust and the like may be efficiently prevented from entering electronic devices such as PCBs, sensors, MEMS microphones, etc.

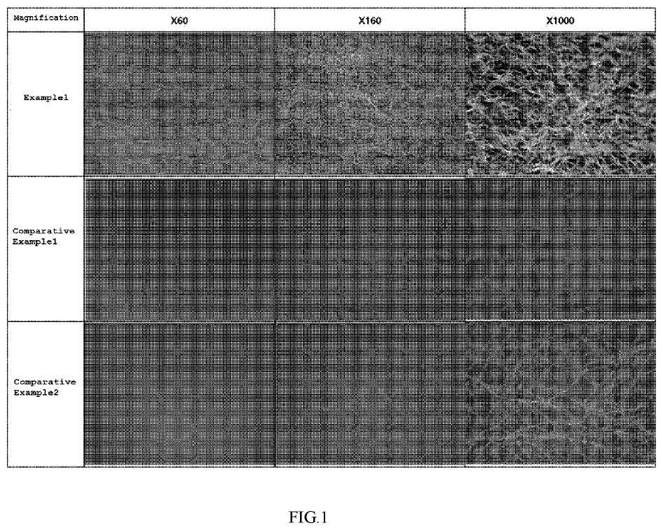

FIG. 1 shows digital microscope images of a polyimide nanomembrane according to an embodiment of the present disclosure, a conventional polyimide membrane, and a conventional PVDF polyimide membrane.

With reference to FIG. 1, the nonwoven fabric of the present disclosure is provided in the form of having pores with a large diameter in which nanofibers are irregularly entangled. By virtue of the pores with a large diameter, air permeability may be greatly improved compared to the conventional polyimide membrane and PVDF polyimide membrane.

A nonwoven fabric is a sheet having a structure of individual fibers or filaments, not in the same way as a woven fabric. A nonwoven fabric may be manufactured through any one process selected from the group consisting of carding, garneting, air-laying, wet-laying, melt blowing, spunbonding, thermal bonding, and stitch bonding.

Another embodiment of the present disclosure pertains to a dustproof nanomembrane 100 including a plurality of pores having an average diameter of 0.5 to 20 μm, with a porosity of 50 to 90%, a thickness of 1 to 30 μm, air permeability of 1 to 200 cm³/cm²/sec, and dust collection efficiency of 95% or more according to the following measurement method. In the method of measuring dust collection efficiency, measurement is performed using an AFT 8130 at a dust size of 5 μm, an air flow rate of 32 L/min, and a measurement area of 100 cm².

The nanomembrane 100 of the present disclosure has the average diameter, porosity, thickness, and air permeability in the above ranges, so that air and sound permeability may not be lowered, and dust collection efficiency may be 95% or more, preferably 98% or more, resulting in excellent dust resistance.

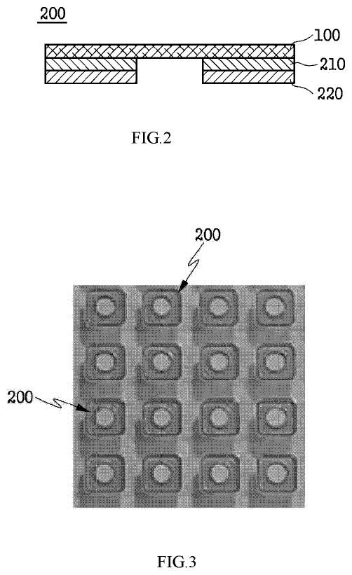

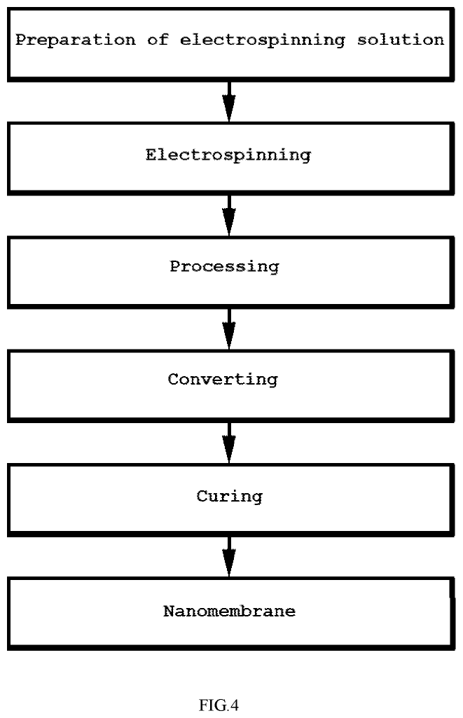

FIG. 2 shows a nanomembrane assembly including the nanomembrane according to still another embodiment of the present disclosure, and FIG. 3 shows a photograph of the nanomembrane assembly.

With reference to FIGS. 2 and 3, the nanomembrane assembly 200 including the nanomembrane 100 further includes a carrier 220 attached to the nanomembrane 100, and the carrier 220 has an opening at the center thereof.

The carrier 220 may be attached to the nanomembrane 100 using an adhesive 210, and the adhesive 210 may be a silicone-based or acrylic adhesive polymer, preferably a silicone-based adhesive, but is not limited thereto.

By attaching the carrier 220 to the nanomembrane 100, durability of the nanomembrane 100 may be improved.

The shape of the nanomembrane assembly 200 may be circular, elliptical, rectangular, rectangular with rounded ends, polygonal, P-shaped, etc., but is not limited thereto, and may vary depending on electronic devices such as PCB s, sensors, MEMS microphones, etc.

Moreover, electronic devices such as PCB s, sensors, MEMS microphones, etc. to which the nanomembrane assembly 200 is attached are capable of blocking entry of foreign substances while introducing sound and air into the inside. As the entry of foreign substances is blocked, durability and the like are improved, such that the service life may be extended.

Yet another embodiment of the present disclosure pertains to a nanomembrane assembly 200 for a microelectromechanical system (MEMS) attached to the MEMS to prevent foreign substances from entering inside of the MEMS, which includes a nanomembrane 100 having a plurality of pores having an average diameter of 0.5 to 20 μm and made of a material having a volume resistance of 1.6 to 2.0×10¹⁶ Ω·cm (ASTM D257) and a dielectric strength of 200 to 600 kV/mm (ASTM D149), an adhesive 210 provided on the nanomembrane, and a carrier 220 provided on the adhesive 210.

As described above, the nanomembrane assembly 200 for MEMSs according to the present disclosure includes the nanomembrane 100 exhibiting excellent dust resistance, and thus entry of foreign substances such as dust and the like may be blocked while air and sound are transmitted into the MEMS, preferably the MEMS microphone.

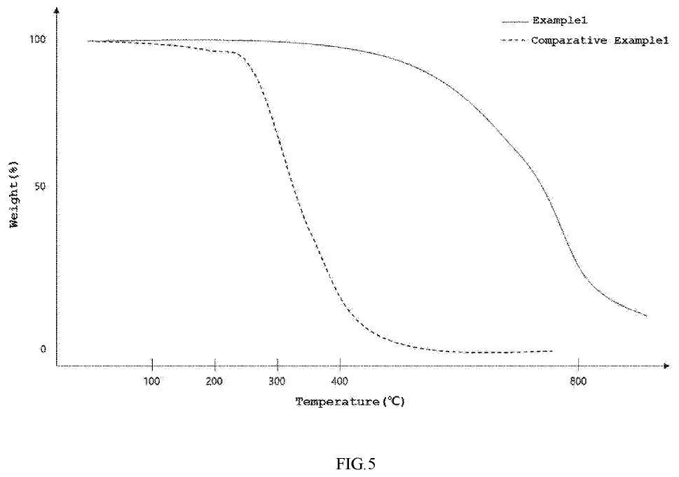

FIG. 4 is a flowchart showing a process of manufacturing a nanomembrane according to still yet another embodiment of the present disclosure.

With reference to FIG. 4, the method of manufacturing the nanomembrane according to the present disclosure includes electrospinning a polyamic acid solution to prepare a precursor, processing the precursor to adjust the density and thickness of the precursor, converting the precursor to determine the shape of the precursor, and curing the converted precursor. During electrospinning, air may be blown in a direction in which the precursor is discharged.

In the present disclosure, the polyamic acid solution may be prepared by dissolving a diamine monomer and a dianhydride monomer in a solvent.

The diamine monomer may be at least one selected from the group consisting of 4,4′-oxydianiline (ODA), 1,3-bis(4-aminophenoxy)benzene (RODA), p-phenylene diamine (p-PDA), and o-phenylene diamine (o-PDA), and is preferably 4,4′-oxydianiline (ODA), p-phenylene diamine (p-PDA), o-phenylene diamine (o-PDA), or mixtures thereof.

The dianhydride monomer may be at least one selected from the group consisting of pyromellitic dianhydride (PMDA), 3,3′,4,4′-benzophenonetetracarboxylic dianhydride (BTDA), 4,4′-oxydiphthalic anhydride (ODPA), 3,4,3′,4′-biphenyltetracarboxylic dianhydride (BPDA), and bis(3,4-dicarboxyphenyl)dimethylsilane dianhydr ide (SiDA).

The solvent may be at least one selected from the group consisting of m-cresol, N-methyl-2-pyrrolidone (NMP), dimethylformamide (DMF), dimethylacetamide (DMAc), dimethyl sulfoxide (DMSO), acetone, diethyl acetate, tetrahydrofuran (THF), chloroform, and γ-butyrolactone, and is preferably a dimethylformamide (DMF) solution.

The polyamic acid solution may have a solid content of 5 to 30 wt % and a solution viscosity of 200 to 300 poise, preferably a solid content of 10 to 20 wt % and a solution viscosity of 220 to 280 poise. The solution viscosity may be measured at a temperature of 23° C. according to the KS M ISO 2555 method. If the solid content thereof is less than 5 wt % and the solution viscosity thereof is less than 200 poise, the polymer content may be low during electrospinning, and fibers may not be produced but beads may be sprayed. On the other hand, if the solid content thereof exceeds 30 wt % and the solution viscosity thereof exceeds 300 poise, solidification may occur during electrospinning, and many nanomembrane defects may occur.

Electrospinning the polyamic acid solution is performed to prepare a precursor. In order to disperse the precursor during electrospinning, air may be blown in a direction in which the precursor is discharged. The direction of the air may be adjusted at various angles from the direction in which the precursor is discharged in order to disperse the precursor.

During electrospinning, the polyamic acid solution is spun from nozzles to prepare a precursor, and the precursor is dispersed due to electrostatic force generated in the spun precursor. Here, air may be blown toward the precursor at a predetermined angle in order to disperse the precursor in a wider range. Due to air pressure, the precursor is dispersed over a wider range and thus accumulates. As such, the solvent contained in the precursor is removed.

In the present disclosure, the precursor may be dispersed in a wider range by blowing air toward the precursor, and the nanomembrane 100 thus manufactured has pores with a large diameter and high air permeability.

Moreover, air may be injected in a horizontal direction in order to efficiently remove the solvent during electrospinning, and the amount of air injected in the horizontal direction and the amount of air injected to disperse the precursor are adjusted, thus controlling the pore size, porosity, etc. of the nanomembrane 100.

During electrospinning, the discharge speed may be 2 to 8 ml/min, preferably 3 to 5 ml/min. If the discharge speed is less than 2 ml/min, the amount of laminated fibers may be small, and thus productivity may decrease or delamination may occur, and the porosity and pore diameter may increase, resulting in deteriorated dust resistance. On the other hand, if the discharge speed exceeds 8 ml/min, the saturated concentration of the solvent in the chamber may increase, and thus the solvent may be non-volatilized, which may cause a problem in that the product is re-dissolved and formed into a film.

Electrospinning may be performed at a voltage of 10 to 100 kV, preferably at 50 to 90 kV. If the voltage is less than 10 kV, electrospinning may not be easily conducted. On the other hand, if the voltage exceeds 100 kV, sparks may occur in vulnerable portions of the insulation during electrospinning, resulting in damage to the product or separation during transport due to static electricity.

Processing the precursor is performed to adjust the density and thickness of the precursor that accumulates during electrospinning, and may be performed through two-stage continuous calendering. Processing the precursor may be performed by applying a pressure of 20 to 200 kgf/cm² at a temperature of 20 to 100° C., preferably by applying a pressure of 30 to 150 kgf/cm² at a temperature of 30 to 80° C. If the temperature is lower than 20° C. and the pressure is less than 20 kgf/cm², durability of the nanomembrane 100 may be decreased due to excessive bulkiness of the nanomembrane 100. On the other hand, if the temperature is higher than 80° C. and the pressure exceeds 200 kgf/cm², sound permeability may be decreased due to low bulkiness of the nanomembrane 100.

Converting the precursor is performed to determine the shape of the processed precursor. A converting process may include cross-cutting such as slitting to obtain an article of a desired width and guillotining to obtain an article of a desired length, and may include, for example, platen or rotary die cutting to obtain an article of a desired shape.

Curing the converted precursor is performed by applying heat thereto, and may be carried out at 200 to 400° C. for 10 to 30 minutes, preferably at 250 to 350° C. for 15 to 25 minutes. During curing, if the temperature is lower than 200° C. and the time is less than 10 minutes, curing may not proceed, and the molecular weight of the material may be lowered by humidity and sunlight, and thus the membrane may be damaged. On the other hand, if the temperature is higher than 300° C. and the time exceeds 30 minutes, thermal shrinkage may occur due to excessive heat.

A better understanding of the present disclosure may be obtained through the following examples.

### Example 1

5 L of a polyamic acid solution having a solid content of 11 wt % and a solution viscosity of 250 poise (KS M ISO 2555, 23° C.) was prepared.

After transferring the prepared polyamic acid solution to a solution tank, it was supplied to a spinning chamber, having 20 nozzles and with a high voltage of 60 kV applied thereto, through a quantitative gear pump, and electrospinning was performed to prepare a precursor. Here, the discharge speed was 4 ml/min, the ratio of the distance between the nozzle and the collector plate to the distance between the nozzle and the tip was 1.2, and the precursor was dispersed by blowing air at a predetermined angle in a direction in which the precursor was discharged.

Thereafter, the precursor was transferred in a roll-to-roll manner and processed by applying a linear pressure of 100 kgf/cm² using a two-stage continuous calendering machine maintained at a temperature of 65° C., followed by a converting process to obtain a converted precursor having a thickness of 5 μm and a unit weight of 3 g/m².

Thereafter, the converted precursor was transferred in a roll-to-roll manner and thermally cured for 20 minutes in a continuous curing furnace maintained at a temperature of 300° C., finally manufacturing a polyimide nanomembrane having a thickness of 4 μm and a unit weight of 2 g/m².

### Example 2

A polyimide nanomembrane was manufactured in the same manner as in Example 1, with the exception that the curing temperature and time in Example 1 were changed to 250° C. and 30 minutes.

### Example 3

A polyimide nanomembrane was manufactured in the same manner as in Example 1, with the exception that the curing temperature and time in Example 1 were changed to 350° C. and 10 minutes.

### Example 4

A polyimide nanomembrane was manufactured in the same manner as in Example 1, with the exception that the discharge speed and the applied voltage in Example 1 were changed to 8 ml/min and 90 kV.

### Example 5

A polyimide nanomembrane was manufactured in the same manner as in Example 1, with the exception that the solid content and solution viscosity of the polyamic acid solution in Example 1 were changed to 12 wt % and 280 poise (KS M ISO 2555, 23° C.), and the applied voltage was changed to 65 kV.

### Example 6

5 L of a polyamic acid solution having a solid content of 8 wt % and a solution viscosity of 200 poise (KS M ISO 2555, 23° C.) was prepared.

After transferring the prepared polyamic acid solution to a solution tank, it was supplied to a spinning chamber, having 20 nozzles and with a high voltage of 60 kV applied thereto, through a quantitative gear pump, and electrospinning was performed to prepare a precursor. Here, the discharge speed was 3 ml/min, the ratio of the distance between the nozzle and the collect or plate to the distance between the nozzle and the tip was 1.2, and the precursor was dispersed by blowing air at a predetermined angle in a direction in which the precursor was discharged.

Thereafter, the precursor was transferred in a roll-to-roll manner and processed by applying a linear pressure of 100 kgf/cm² using a two-stage continuous calendering machine maintained at a temperature of 65° C., followed by a converting process to obtain a converted precursor having a thickness of 1.5 μm and a unit weight of 1 g/m².

Thereafter, the converted precursor was transferred in a roll-to-roll manner and thermally cured for 10 minutes in a continuous curing furnace maintained at a temperature of 300° C., finally manufacturing a polyimide nanomembrane having a thickness of 1 μm and a unit weight of 0.5 g/m².

### Example 7

5 L of a polyamic acid solution having a solid content of 15 wt % and a solution viscosity of 300 poise (KS M ISO 2555, 23° C.) was prepared.

After transferring the prepared polyamic acid solution to a solution tank, it was supplied to a spinning chamber, having 20 nozzles and with a high voltage of 80 kV applied thereto, through a quantitative gear pump, and electrospinning was performed to prepare a precursor. Here, the discharge speed was 3 ml/min, the ratio of the distance between the nozzle and the collect or plate to the distance between the nozzle and the tip was 1.2, and the precursor was dispersed by blowing air at a predetermined angle in a direction in which the precursor was discharged.

Thereafter, the precursor was transferred in a roll-to-roll manner and processed by applying a linear pressure of 100 kgf/cm² using a two-stage continuous calendering machine maintained at a temperature of 65° C., followed by a converting process to obtain a converted precursor having a thickness of 6 μm and a unit weight of 4 g/m².

Thereafter, the converted precursor was transferred in a roll-to-roll manner and thermally cured for 10 minutes in a continuous curing furnace maintained at a temperature of 300° C., finally manufacturing a polyimide nanomembrane having a thickness of 5 μm and a unit weight of 3 g/m².

### Comparative Example 1

5 L of an electrospinning solution having a solid content of 15 wt % and a solution viscosity of 250 poise (KS M ISO 2555, 23° C.) was prepared by dissolving polyvinylidene difluoride (PVDF) in a dimethylformamide (DMF) solvent.

After transferring the prepared electrospinning solution to a solution tank, it was supplied to a spinning chamber, having 20 nozzles and with a high voltage of 60 kV applied thereto, through a quantitative gear pump, and electrospinning was performed, thus manufacturing a PVDF nanomembrane. Here, the discharge speed was 4 ml/min, and the ratio of the distance between the nozzle and the collector plate to the distance between the nozzle and the tip was 1.2.

### Comparative Example 2

5 L of a polyamic acid solution having a solid content of 11 wt % and a solution viscosity of 250 poise (KS M ISO 2555, 23° C.) was prepared.

After transferring the prepared polyamic acid solution to a solution tank, it was supplied to a spinning chamber, having 20 nozzles and with a high voltage of 60 kV applied thereto, through a quantitative gear pump, and electrospinning was performed to prepare a precursor. Here, the discharge speed was 4 ml/min, and the ratio of the distance between the nozzle and the collector plate to the distance between the nozzle and the tip was 1.2.

Thereafter, thermal curing was performed for 20 minutes in a continuous curing furnace maintained at a temperature of 300° C., finally manufacturing a polyimide nanomembrane having a thickness of 25 μm and a unit weight of 13 g/m².

### Test Example 1

The surface of the nanomembrane manufactured in each of Example 1 and Comparative Examples 1 and 2 was observed using a digital microscope at 60×, 160×, and 1000× magnifications, and the results thereof are shown in FIG. 1.

With reference to FIG. 1, in the nanomembrane (Example 1) according to the present disclosure, it can be seen that the pore diameter was very large at 1000× magnification, based on which air permeability was evaluated to be superior compared to the PVDF nanomembrane (Comparative Example 1) and the conventional polyimide nanomembrane (Comparative Example 2).

### Test Example 2

The unit weight, thickness, porosity, air permeability, and pore size of the nanomembranes manufactured in Examples 1 to 7 and Comparative Examples 1 and 2 were measured according to the following measurement methods, and the results thereof are shown in Table 1 below.

[Measurement Method]

Unit weight: KS K 0514 or ASTM D 3776

Thickness: KS K 0506 or KS K ISO 9073-2, ISO 4593

Porosity: The ratio of the air volume relative to the total volume of the nanofiber membrane was calculated according to Equation 1 below (the total volume was determined by manufacturing a rectangular or circular sample and measuring the width, length, and thickness thereof, and the air volume was determined by measuring the mass of the sample and subtracting the polymer volume, which was calculated back from the density, from the total volume).

Porosity (%)=[1−(A/B)]×100={1−[(C/D)/B]}×100 [Equation 1]

In Equation 1, A is the density of the nanomembrane, B is the density of the nanomembrane polymer, C is the weight of the nanomembrane, and D is the volume of the nanomembrane.

Air permeability: Measurement was performed according to ASTM D 737 under conditions of an area of 38 cm² and a static pressure of 125 Pa (cm³/cm²/s may be converted to CFM, and the conversion factor is 0.508016 and unit thereof is ft³/ft²/min (CFM)).

Average pore diameter: The average pore size and pore size distribution were measured at the limiting pore diameter, which is the pore size in the narrowest zone, using a capillary flow porometer (CFP) specified in ASTM F316.

TABLE 1

| | | | | Air | | |
|---|---|---|---|---|---|---|
| | | | | perme- | Pore | Average |
| | Unit | Thick- | | ability | diam- | pore |
| Classi- | weight | ness | Porosity | (cm³/cm²/ | eter | diameter |
| fication | (g/m²) | (μm) | (%) | sec) | (μm) | (μm) |
| Example 1 | 2 | 4 | 85 | 120 | 4-20 | 10 |
| Example 2 | 2 | 4 | 85 | 120 | 4-20 | 10 |
| Example 3 | 2 | 4 | 85 | 120 | 4-20 | 10 |
| Example 4 | 2 | 4 | 70 | 80 | 3-8 | 5 |
| Example 5 | 2 | 4 | 90 | 150 | 6-35 | 20 |
| Example 6 | 0.5 | 1 | 30 | 40 | 0.5-4 | 2 |
| Example 7 | 3 | 5 | 75 | 110 | 5-30 | 15 |
| Comparative | 2 | 4 | 80 | 30 | 0.5-3 | 1.5 |
| Example 1 | | | | | | |
| Comparative | 13 | 25 | 80 | 5 | 1-5 | 2 |
| Example 2 | | | | | | |

As is apparent from Table 1, the polyimide nanomembranes (Examples 1 to 7) manufactured according to the present disclosure exhibited vastly superior air permeability compared to the PVDF nanomembrane (Comparative Example 1).

In addition, even when the porosity was as low as 30% (Example 6), air permeability was superior compared to the PVDF nanomembrane having a porosity of 80% (Comparative Example 1).

In addition, the polyimide nanomembrane (Comparative Example 2) manufactured according to the conventional method showed very low air permeability compared to the polyimide nanomembrane s (Examples 1 to 7) manufactured according to the present disclosure.

### Test Example 3

A nanomembrane assembly was manufactured by attaching an acrylic adhesive composition (polyacrylamide) to the nanomembrane manufactured in each of Examples 1 to 7 and Comparative Examples 1 and 2 and attaching a polyimide film as a carrier thereto. Sound transmission loss, air permeability, and dust resistance were evaluated according to the following measurement method s using the nanomembrane assembly, and the results thereof are shown in Table 2 below.

[Measurement Method]

Sound transmission loss: A change in sensitivity of a microphone was confirmed in the frequency range of a speaker (100-20,000 Hz), and the extent of sound loss was evaluated by measuring sensitivity when the nanomembrane assembly was attached to a microelectromechanical system (MEMS) recognizing microphone sensitivity and when not attached.

Dust collection efficiency (dust resistance): Measurement was performed using an AFT 8130 at a dust size of 5 μm, an air flow rate of 32 L/min, and a measurement area of 100 cm².

TABLE 2

| | Sound transmission loss | Dust |
|---|---|---|
| Classification | (insertion loss) (dB/pa@94 dB) | resistance (%) |
| Example 1 | 1.5 | 98.5 |
| Example 2 | 1.5 | 96.0 |
| Example 3 | 1.5 | 97.5 |
| Example 4 | 3.5 | 99.0 |
| Example 5 | 0.5 | 95.0 |
| Example 6 | 2.5 | 99.0 |
| Example 7 | 1.2 | 95.5 |
| Comparative | 1.0 | 99.5 |
| Example 1 | | |
| Comparative | 6.5 | 99.5 |
| Example 2 | | |

As is apparent from Table 2, when using the nanomembranes according to the present disclosure (Examples 1 to 7), dust resistance was 95% or more and sound transmission loss was 3.5 dB or less.

In contrast, in the polyimide nanomembrane manufactured by the conventional method (Comparative Example 2), excellent dust resistance of 99.5% but very large sound transmission loss of 6.5 dB resulted.

### Test Example 4

The thermal shrinkage of the nanomembranes manufactured in Examples 1 to 7 and Comparative Examples 1 and 2 was evaluated according to the following measurement method, and the results thereof are shown in Table 3 below.

[Measurement Method]

Thermal shrinkage (%): The nanomembrane was heat-treated for 30±2 minutes in an oven at a temperature of 300° C.±2° C. and then allowed to stand for 24 hours under conditions of a temperature of 23° C.±2° C. and a humidity (relative humidity) of 50%±5%, after which a change in length thereof was measured.

TABLE 3

| Classification | Thermal shrinkage (%) |
|---|---|
| Example 1 | <1 |
| Example 2 | <1 |
| Example 3 | <1 |
| Example 4 | <1 |
| Example 5 | <1 |
| Example 6 | <1 |
| Example 7 | <1 |
| Comparative | 15 |
| Example 1 | |
| Comparative | <1 |
| Example 2 | |

As is apparent from Table 3, in the polyimide nanomembranes (Examples 1 to 7 and Comparative Example 2), the thermal shrinkage was less than 1%, demonstrating superior heat resistance compared to the PVDF nanomembrane (Comparative Example 1).

### Test Example 5

In order to measure the weight reduction due to heat of the nanomembranes manufactured in Example 1 and Comparative Example 1, the weight thereof was measured according to the following measurement method, and the results thereof are shown in FIG. 5.

[Measurement Method]

Weight reduction: 0.5 g of each sample was prepared, the sample was heated while raising the temperature from room temperature to 800° C. at a rate of 20° C./min under nitrogen conditions using a TGA analyzer (Thermoplus EVO II TG8120, made by Rigaku), and a change in weight thereof was measured.

With reference to FIG. 5, in the polyimide nanomembrane (Example 1) according to the present disclosure, the weight reduction at 300° C. was 1% or less, but in the PVDF nanomembrane (Comparative Example 1), the weight reduction was much greater than 1%.

Therefore, it was found that both dust resistance and air permeability are superior in the nanomembrane according to the present disclosure.

In addition, it can be confirmed that the nanomembrane according to the present disclosure has superior heat resistance and is suitable for use in MEMS microphones.

As described hereinbefore, preferred embodiments of the present disclosure have been described in detail. The description of the present disclosure is for illustrative purposes, and those skilled in the art will appreciate that various modifications are possible without departing from the technical spirit or essential features of the present disclosure.

Therefore, the scope of the present disclosure is indicated by the following claims rather than the detailed description, and all changes or modifications derived from the meaning, scope, and equivalent concepts of the claims are construed to be included in the scope of the present disclosure.

1. A nanomembrane comprising a plurality of pores having an average diameter of 0.5 to 20 μm, with a maximum pore diameter of 30 μm, a minimum pore diameter of 0.1 μm, and a porosity of 50 to 90%.

2. The nanomembrane according to claim 1, wherein a material constituting the nanomembrane has a volume resistance of 1.6 to 2.0×10¹⁶ Ω·cm (ASTM D257) and a dielectric strength of 200 to 600 kV/mm (ASTM D149).

3. The nanomembrane according to claim 2, wherein the material is polyimide (PI), polyacrylonitrile (PAN), polymethyl methacrylate (PMMA), polystyrene (PS), styrene methyl methacrylate (SMMA), or styrene acrylonitrile (SAN).

4. The nanomembrane according to claim 1, wherein the nanomembrane has a thickness of 1 to 30 μm.

5. The nanomembrane according to claim 1, wherein air permeability of the nanomembrane is 1 to 200 cm³/cm²/sec.

6. The nanomembrane according to claim 1, wherein a unit weight of the nanomembrane is 0.1 to 10 g/m².

7. The nanomembrane according to claim 1, wherein a density of the nanomembrane is 0.1 to 1.0 g/cm³.

8. The nanomembrane according to claim 1, wherein dust collection efficiency of the nanomembrane is 95% or more according to a measurement method below.
[Method of Measuring Dust Collection Efficiency]
Using an AFT 8130 at a dust size of 5 μm, an air flow rate of 32 L/min, and a measurement area of 100 cm²

9. The nanomembrane according to claim 1, wherein a thermal shrinkage of the nanomembrane at 300° C. is 1% or less.

10. The nanomembrane according to claim 1, wherein a weight reduction of the nanomembrane at 300° C. is 1% or less.

11. The nanomembrane according to claim 1, wherein the nanomembrane is configured such that nanofibers are integrated in a form of a non-woven fabric.

12. A dustproof nanomembrane comprising a plurality of pores having an average diameter of 0.5 to 20 μm, with a porosity of 50 to 90%, a thickness of 1 to 30 μm, air permeability of 1 to 200 cm³/cm²/sec, and dust collection efficiency of 95% or more according to a measurement method below.
[Method of measuring dust collection efficiency]
Using an AFT 8130 at a dust size of 5 μm, an air flow rate of 32 L/min, and a measurement area of 100 cm²

13. A dustproof nanomembrane assembly comprising the nanomembrane according to claim 1, an adhesive provided on one surface of the nanomembrane, and a carrier provided on one surface of the adhesive.

14. A nanomembrane assembly for a microelectromechanical system (MEMS) attached to a microelectromechanical system to prevent foreign substances from entering inside of the microelectromechanical system, comprising a nanomembrane having a plurality of pores having an average diameter of 0.5 to 20 μm and made of a material having a volume resistance of 1.6 to 2.0×10¹⁶ Ω·cm (ASTM D257) and a dielectric strength of 200 to 600 kV/mm (ASTM D149), an adhesive provided on the nanomembrane, and a carrier provided on the adhesive.

15. A method of manufacturing a nanomembrane, comprising:
electrospinning a polyamic acid solution to prepare a precursor;
processing the precursor to adjust a density and thickness of the precursor;
converting the precursor to determine a shape of the precursor; and
curing the converted precursor,
wherein, in electrospinning the polyamic acid solution, air is blown in a direction in which the precursor is discharged.

16. The method according to claim 15, wherein the polyamic acid solution has a solid content of 5 to 30 wt % and a solution viscosity of 200 to 300 poise.

17. The method according to claim 15, wherein a discharge speed during electrospinning is 3 to 8 ml/min.

18. The method according to claim 15, wherein processing the precursor is performed by applying a pressure of 20 to 200 kgf/cm² at a temperature of 20 to 100° C.

19. The method according to claim 15, wherein curing the converted precursor is performed for 10 to 30 minutes at 200 to 400° C.
